(19) United States
(12) Patent Application Publication
(10) Pub. No.: US 2011/0199505 A1
(43) Pub. Date: Aug. 18, 2011

(54) IMAGE PROCESSING APPARATUS AND IMAGE PROCESSING METHOD

(75) Inventor: Yasuhiko Teranishi, Kanagawa-ken (JP)

(73) Assignee: VICTOR COMPANY OF JAPAN, LIMITED, Yokohama-shi (JP)

(21) Appl. No.: 13/119,373

(22) PCT Filed: Sep. 6, 2010
(86) PCT No.: PCT/JP2010/065196

§ 371 Date: Mar. 16, 2011

(30) Foreign Application Priority Data
Nov. 13, 2009 (JP) 2009-260364

(51) Int. Cl. G06K 9/46; H04N 5/228

(52) U.S. Cl. 348/222.1; 382/195; 348/E05.031

(57) ABSTRACT

An image processing apparatus is provided that comprises: an image acquisition unit that acquires an image; a position specification unit that specifies one facial image from the image; a face correlation unit that correlates the specified facial image with face information obtained by compiling one or more stored feature values stored in a storage unit, thereby identifying one or more correlated feature values; a feature value extraction unit that extracts an extracted feature value of the specified facial image; and a storage control unit that compares the extracted feature value with the one or more correlated feature values of the face information correlated with the specified facial image, and causes the storage unit to additionally store the extracted feature value, as a storable feature value, as the face information when a predetermined condition is satisfied.

### TECHNICAL FIELD

The invention relates to an image processing apparatus and an image processing method configured to store a feature value of a facial image in order to specify a subject.

### BACKGROUND ART

In recent years, there have been widely used image processing apparatus such as digital still cameras or digital video cameras configured to recognize a facial image (an image of a face) of a person designated by the user in a generated image and to automatically adjust focus or exposure to the recognized facial image. Such an image processing apparatus extracts feature values from a facial image designated by the user and stores the feature values in order to recognize the facial image later. However, the feature values of the facial image are influenced by the face orientation. Accordingly, even when the subject is the same person, the subject may be misrecognized as a different person if the face orientation of the subject changes too much.

In this regard, there is disclosed a technique to estimate the face orientation by using typical feature points of the face, then to convert feature values in other feature locations in which individuals have distinctive features, to feature values in the estimated orientation by using an average three-dimension model of the face, and to compare the feature values in the locations after the conversion to recognize the person (Patent Document 1, for example).

Patent Document 1: Japanese Patent Application Publication No. 2009-53916

### SUMMARY OF THE INVENTION

### Problems to be Solved by the Invention

By using the above-described technique according to

Patent Document 1, certain robustness to the face orientation can be provided to facial image recognition. However, the facial image after change of the posture (the face orientation) is generated merely by prediction. Accordingly, there is a risk of misjudgment in face recognition processing in the case of a large change in the face orientation or in the facial expression.

Meanwhile, accuracy in facial image identification in face recognition processing can be improved if an image processing apparatus acquires multiple facial images of the same person with different orientations and expressions of the face and extracts and stores feature values in advance. However, to achieve this, it is necessary to repeat capturing and registering operations while asking a person of a subject to change the orientation and the expression of the face several times. This process bothers not only the user but also the person of the subject. In addition, the user judges whether or not facial images sufficiently different in orientation and the expression of the face are captured and registered during these capturing and registering operations. Accordingly, there may be a case where multiple similar feature values are registered and thereby accuracy in identification of the facial image decreases.

In view of these problems, it is an object of the invention to provide an image processing apparatus and an image processing method which are capable of extracting an appropriate feature value for reliably specifying a facial image without bothering the user.

### Means for Solving the Problems

In order to solve the above problems, an image processing apparatus according to the invention comprises: an image acquisition unit configured to acquire an image; a position specification unit configured to specify one facial image from within the image; a face correlation unit configured to correlate the specified facial image with face information obtained by compiling one or more feature values stored in a storage unit; a feature value extraction unit configured to extract the feature value of the specified facial image; and a storage control unit configured to compare the extracted feature value with one or more feature values of the face information correlated with the specified facial image, and to cause the storage unit to additionally store the extracted feature value as the face information when a predetermined condition is satisfied.

The predetermined condition may be that similarities between the extracted feature value and all the one or more feature values of the face information correlated with the specified facial image are below a predetermined value.

The image processing apparatus may further comprise: a display control unit configured to cause a display unit to display an image indicating the number of the actually stored feature values in comparison with an upper limit number of the storable feature values.

In order to solve the above problems, another image processing apparatus according to the invention comprises: an image acquisition unit configured to acquire an image; a position specification unit configured to specify one facial image from within the image; a face correlation unit configured to correlate the specified facial image with face information obtained by compiling one or more feature values and face orientations stored in a storage unit; a face orientation derivation unit configured to derive a face orientation of the specified facial image; a feature value extraction unit configured to extract the feature value of the specified facial image; and a storage control unit configured to compare the derived face orientation with one or more face orientations of the face information correlated with the specified facial image, and to cause the storage unit to additionally store the extracted feature value and the derived face orientation as the face information when a predetermined condition is satisfied.

The predetermined condition may be that the derived face orientation is not contained in any of one or more ranges including the face orientations regarding the face information correlated with the specified facial image among a predetermined number of ranges regarding the face orientations categorized based on a pitch angle and a yaw angle.

The image processing apparatus may further comprise: a display control unit configured to cause a display unit to display an image indicating any one or both of the number of the actually stored feature values in comparison with an upper limit number of the storable feature values, and ranges including the actually stored face orientations in comparison with a predetermined number of ranges regarding the face orientations categorized based on the pitch angle and the yaw angle.

In order to solve the above problems, an image processing method according to the invention comprises the steps of: acquiring an image and specifying one facial image from within the image; correlating the specified facial image with face information obtained by compiling one or more feature values; extracting a feature value of the specified facial image; and comparing the extracted feature value with one or more feature values of the face information correlated with the specified facial image and additionally storing the extracted feature value as the face information when a predetermined condition is satisfied.

In order to solve the above problems, another image processing method according to the invention comprises the steps of: acquiring an image and specifying one facial image from within the image; correlating the specified facial image with face information obtained by compiling one or more feature values and one or more face orientations; deriving a face orientation of the specified facial image; and comparing the derived face orientation with one or more face orientations of the face information correlated with the specified facial image, and additionally storing the specified feature value of the facial image and the face orientation as the face information when a predetermined condition is satisfied.

### Effects of the Invention

According to the invention as described above, it is possible to extract an appropriate feature value for reliably specifying a facial image without bothering a user.

### BRIEF DESCRIPTION OF THE DRAWINGS

FIGS. 1A and 1B are external views showing an example of an image processing apparatus.

FIG. 2 is a functional block diagram showing a schematic configuration of an image processing apparatus according to a first embodiment.

FIGS. 3A, 3B and 3C are explanatory views for explaining face orientations.

FIGS. 4A and 4B are explanatory views for explaining control to store feature values in a feature value storage unit according to the first embodiment.

FIG. 5 is a flowchart showing a process flow of an image processing method according to the first embodiment.

FIG. 6 is a functional block diagram showing a schematic configuration of an image processing apparatus according to a second embodiment.

FIGS. 7A and 7B are explanatory views for explaining classification of facial images based on face orientations according to the second embodiment.

FIGS. 8A and 8B are explanatory views for explaining an image showing the number of feature values and an image showing ranges including a face orientation.

FIGS. 9A, 9B and 9C are explanatory views for explaining processing when feature values are acquired from an external apparatus.

FIG. 10 is a flowchart showing a process flow of an image processing method according to the second embodiment.

### EXPLANATION OF REFERENCE NUMERALS

### Embodiments for Carrying Out the Invention

Preferred embodiments of the invention are described below in detail with reference to the accompanying drawings.

It is to be understood that dimensions, materials, other concrete numerical values, and the like shown in the embodiments are merely examples for facilitating understanding of the invention and are not intended to limit the scope of the invention unless otherwise specifically stated. In the specification and the drawings, constituents having substantially the same functions and configurations are designated by the same reference numerals in order to omit duplicate explanations. Moreover, illustrations of constituents which are not directly related to the invention are omitted.

### First Embodiment

### Image Processing Apparatus 100

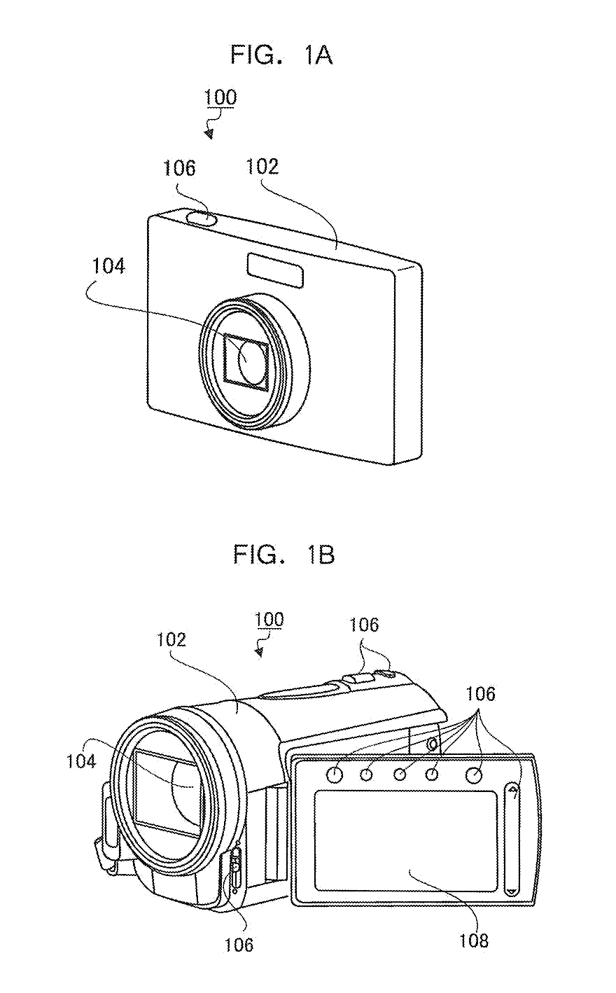

FIGS. 1A and 1B are external views showing an example of image processing apparatus 100. FIG. 1A shows a digital still camera as image processing apparatus 100 while FIG. 1B shows a video camera as image processing apparatus 100. Image processing apparatus 100 is portable and includes body 102, image capturing lens 104, operating unit 106, and viewfinder 108 functioning as a display unit.

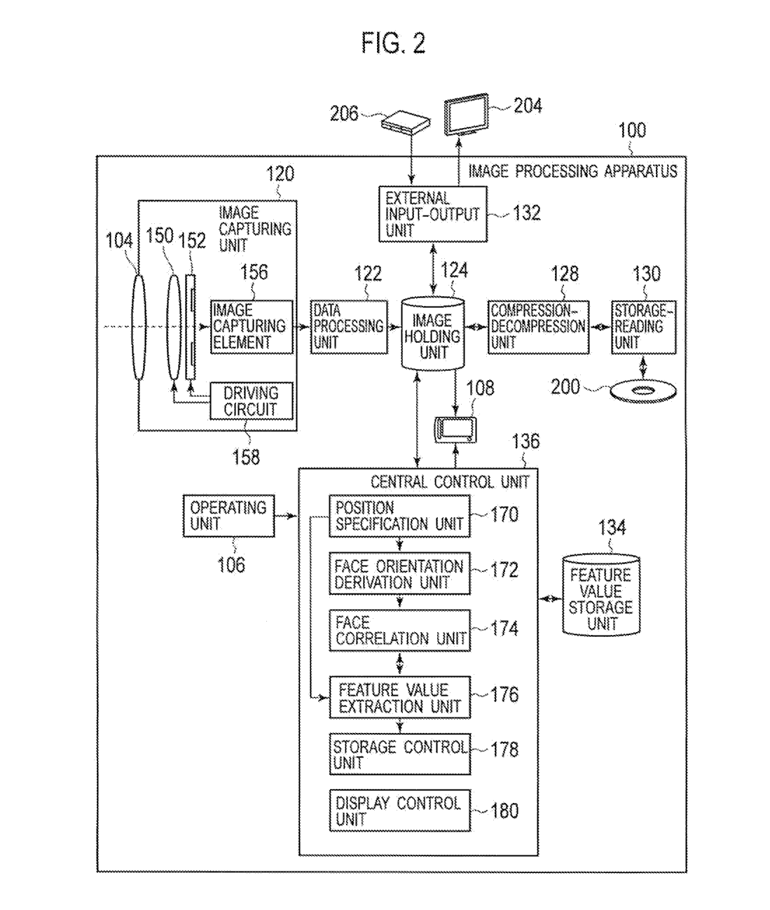

FIG. 2 is a functional block diagram showing the schematic configuration of image processing apparatus 100 according to a first embodiment. Here, the video camera shown in FIG. 1B is indicated as image processing apparatus 100. Image processing apparatus 100 of this embodiment aims to specify one facial image from captured image data and to newly extract and store feature values which are different from a feature value previously stored regarding the facial image, i.e., extract and store feature values of various facial images of a single person having different orientations and expressions of the face. The feature values of the various facial images thus extracted and stored can be used for later recognizing an arbitrary facial image among the images (a recognition mode).

Image processing apparatus 100 includes operating unit 106, image capturing unit 120, data processing unit 122, image holding unit 124, viewfinder 108, compression-decompression unit 128, storage-reading unit 130, external input-output unit 132, feature value storage unit 134, and central control unit 136.

Operating unit 106 includes a switch such as operating keys having a release switch, a cross key, a joystick and is configured to accept operating inputs by a user. Alternatively, operating unit 106 may be formed by arranging a touch panel on a display surface of viewfinder 108 to be described later.

Image capturing unit 120 includes focusing lens 150 used for focus adjustment, diaphragm 152 used for exposure adjustment, image capturing element 156 configured to perform photoelectric conversion of light entering through image capturing lens 104 and to perform A/D conversion into digital image data, and driving circuit 158 configured to drive focusing lens 150 and diaphragm 152. Image capturing unit 120 functions as an image acquisition unit configured to acquire an image (image data) of a subject in an image capturing direction, and outputs the acquired image data to data processing unit 122.

Data processing unit 122 subjects the image data output from image capturing unit 120 to predetermined processing including white balance processing, noise reduction processing, level correction processing, A/D conversion processing, color correction processing (gamma correction processing, knee processing), and the like and outputs the image data after the processing to image holding unit 124.

Image holding unit 124 includes a RAM (random access memory), a flash memory, a HDD (hard disk drive) or the like and is configured to temporarily store the image data input from data processing unit 122, compression-decompression unit 128, and external input-output unit 132.

Viewfinder 108 includes a liquid crystal display, an organic EL (electroluminescence) display or the like and functions as a display unit configured to display the image data that are output from data processing unit 122 and compression-decompression unit 128 and held by image holding unit 124 and to display indicated items linked to operating unit 106. The user can check images (pictures) displayed on viewfinder 108 at the time of image capturing and images of image data to be stored by storage-reading unit 130 to be described later. Moreover, the user can hold a subject in a desired position and at desired spatial position by operation of operating unit 106 while visually checking the image displayed on viewfinder 108. Furthermore, viewfinder 108 displays an image indicating the number of actually stored feature values for an upper limit number of storable feature values to be described later.

Compression-decompression unit 128 encodes the image data output from data processing unit 122 into encoded data in accordance with a predetermined encoding method such as M-JPEG (Motion JPEG), MPEG (Moving Picture Experts Group)-2 or H.264 and outputs the encoded data to storage-reading unit 130.

Meanwhile, compression-decompression unit 128 outputs to image holding unit 124 image data obtained by decoding the encoded data, which are encoded in accordance with the predetermined encoding method and read from storage medium 200 by storage-reading unit 130.

Storage-reading unit 130 stores the encoded data encoded by compression-decompression unit 128 in arbitrary storage medium 200. An optical disc medium such as a DVD (digital versatile disc) or a BD (Blu-ray disc), or any other medium such as a RAM, an EEPROM, a non-volatile RAM, a flash memory or a HDD is applicable to arbitrary storage medium 200. Here, storage medium 200 is attachable and detachable, but may be integrated with image processing apparatus 100. Meanwhile, storage-reading unit 130 reads the encoded data from storage medium 200 that stores the encoded data which are the image data encoded in accordance with the predetermined encoding method, and outputs the encoded data to compression-decompression unit 128.

External input-output unit 132 outputs the image data held by image holding unit 124 to display device 204 connected to image processing apparatus 100. Meanwhile, external input-output unit 132 is connected to external image player device 206 such as a DVD player, a BD player or a HDD player, and is configured to receive image data output from the image output device and to output the image data to image holding unit 124.

Feature value storage unit 134 includes a RAM, a flash memory, a HDD or the like and functions as a storage unit configured to store pieces of face information obtained by compiling one or multiple feature values extracted from facial images of the same person as many as the number of the same persons in accordance with an instruction by a storage control unit to be described later.

Central control unit 136 includes a semiconductor integrated circuit having a central processing unit (CPU) and a signal processing device (DSP: digital signal processor) and is configured to manage and control entire image processing apparatus 100 by use of a predetermined program.

Meanwhile, central control unit 136 also functions as position specification unit 170, face orientation derivation unit 172, face correlation unit 174, feature value extraction unit 176, storage control unit 178, and display control unit 180.

Image processing apparatus 100 of this embodiment specifies one facial image from the captured image data and extracts and stores a new feature value which is different from the feature value previously stored regarding the face in a registration mode, and uses this feature value for recognizing the face in the image in a recognition mode. In the following, image processing apparatus 100 is described separately based on the registration mode and the recognition mode.

(Registration Mode)

In the registration mode, position specification unit 170 specifies (selects) one facial image from the image data acquired by image capturing unit 120 and held by image holding unit 124 in response to a user input by way of operating unit 106 and tracks the facial image by using an existing image processing technique. Then, position specification unit 170 outputs image information related to the facial image for each frame to face orientation derivation unit 172 and feature value extraction unit 176. When multiple facial images are detected, position specification unit 170 similarly tracks the facial images and outputs the image information of all those facial images to feature value extraction unit 176.

Meanwhile, image capturing unit 120 is used herein as an image acquisition unit. However, without limitation to the foregoing, storage-reading unit 130 or external input-output unit 132 may function as the image acquisition unit and position specification unit 170 may specify one facial image based on images acquired by storage-reading unit 130 or external input-output unit 132.

Such specification of one facial image is carried out by causing viewfinder 108 to display the image based on the image data held by image holding unit 124 and allowing the user to select one facial image by operation of operating unit 106. Meanwhile, when a touch panel serving as operating unit 106 is overlapped with the display surface of viewfinder 108, specification of one facial image may be carried out by allowing the user to touch a region corresponding to a position of one facial image by way of the touch panel. Further, position specification unit 170 may automatically select all facial images existing within the screen, and display control unit 180 to be described later may display “which person do you register?” on the screen with multiple frames being displayed to surround all the selected images and may allow the user to select one of the facial images therefrom.

Alternatively, position specification unit 170 may locate a person in a subject so as to display the face in a predetermined region of the center portion within the screen, for example, and may specify the facial image in the region in the image corresponding to the predetermined region at arbitrary timing based on an operation input by the user. The user may be allowed to designate the predetermined region within the screen. In this case, display control unit 180 displays an index such as a rectangular frame, for example, in a superposed manner on a boundary of the predetermined region displayed on viewfinder 108.

In this embodiment, position specification unit 170 extracts the facial images by detecting feature points indicating features of organs such as the eyes, nose, mouth, and the like constituting the faces by scanning a search region in a predetermined size in the image in order to track the facial images. However, the measure to extract the facial images is not limited to detection of the feature points. It is also possible to extract the facial images by detecting skin color regions or by pattern matching, for example.

Position specification unit 170 outputs image information containing at least coordinates of the facial image and the size of the facial image to face orientation derivation unit 172 and outputs image information containing at least the coordinates of the facial image, the size of the facial image, and a probability of the facial image to feature value extraction unit 176. The coordinates of the facial image indicate relative coordinates of a face region to an image size. The size of the facial image indicates a relative size of the face region to the image size. The probability of the facial image indicates certainty that the facial image is the image of the face, which may be derived as a similarity indicating a degree of similarity to a standard facial image, for example. In the meantime, position specification unit 170 may weight this similarity based on a result of detection of the skin color regions. For example, the similarity may be modified to a lower value if there are fewer skin color regions.

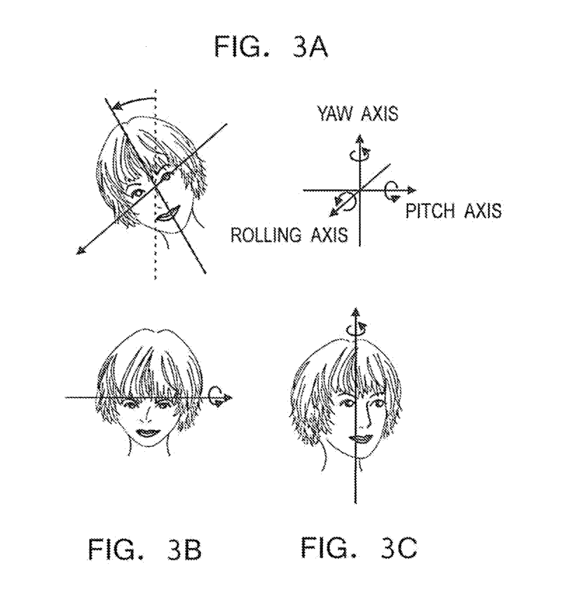

FIG. 3 is an explanatory view for explaining face orientations. The image information also contains a roll angle of the facial image for rotation correction of the facial image together with the coordinates of the facial image, the size of the facial image, and the probability of the facial image as described previously. Here, the roll angle of the facial image to be output to feature value extraction unit 176 is a rotation angle of the facial image around a rolling axis to be defined in FIG. 3A. Meanwhile, definitions of a pitch angle (a rotation angle around a pitch axis) and a yaw angle (a rotation angle around a yaw axis) to be described later are also shown in FIG. 3B and FIG. 3C.

Face orientation derivation unit 172 reads the facial image that position specification unit 170 specifies from the image data held by image holding unit 124 based on the coordinates of the facial image and the size of the facial image indicated in the image information output by position specification unit 170, and derives the face orientation other than the roll angle, i.e., the pitch angle and the yaw angle of the face from outline information on the eyes, the mouth, and the face representing the feature points of the facial image (see FIGS. 3B and 3(c)).

Feature value extraction unit 176 reads the facial image from the image data held in the image holding unit 124 based on the coordinates of the facial image and the size of the facial image indicated in the image information output from position specification unit 170. Then, the facial image thus read out is subjected to resolution conversion or rotation correction in the roll angle direction based on the size of the facial image and the roll angle of the facial image indicated in the image information, and is converted into a normalized facial image (which is erected in a predetermined size).

Meanwhile, feature value extraction unit 176 extracts the feature value of the facial image specified by position specification unit 170 based on the facial image converted by itself and on the pitch angle and the yaw angle representing the face orientation derived by face orientation derivation unit 172. Specifically, first, feature value extraction unit 176 further subjects the facial image after the normalization to affine transformation based on the pitch angle and the yaw angle of the face derived by face orientation derivation unit 172, thereby modifying the facial image to a facial image of the full face.

Then, feature value extraction unit 176 attempts detection of the feature points of the facial image after the affine transformation. Here, in order to avoid a situation of an increase in the process load consumed for detection of the feature points, the feature points of the facial image after the affine transformation are extracted not from the facial image after the affine transformation but by performing the affine transformation of the feature points of the facial image before the affine transformation which are detected in advance. From the feature points of the facial image after the affine transformation, the probability of being the feature point indicating the certainty that each feature point is the feature point of each part of the face is derived for each of the feature points. Here, for example, if the person of the subject closes the eyes, then the probability of being the feature point of the eye becomes lower.

Moreover, feature value extraction unit 176 judges whether or not the facial image is the facial image worth processing. A Gabor jet, for example, is extracted as the feature value of the facial image when the pitch angle of the facial image is in a range from −15° to +15°, the yaw angle of the facial image is in a range from −30° to +30°, and the probability of the facial image indicated in the image information and the probability of being the feature point satisfy given conditions which are predetermined so as to respectively correspond thereto.

A Gabor filter used for finding the Gabor jet is a filter having both a direction selectivity and a frequency characteristic. Feature value extraction unit 176 performs convolution of the facial image by using multiple Gabor filters having mutually different directions and frequencies. A set of multiple scalar values thus obtained is called the Gabor jet. Feature value extraction unit 176 finds the Gabor jet as a local feature value in the vicinity of the feature point on the facial image.

Then, feature value extraction unit 176 outputs the feature value extracted based on the feature point of the facial image after the affine transformation to face correlation unit 174. Here, the feature value is expressed as a vector value representing a set of groups of multiple scalar values (the Gabor jets). One vector value is extracted from one facial image.

Face correlation unit 174 first judges whether or not the facial image specified by position specification unit 170 in response to the user input and the face information obtained by compiling the feature values extracted from the facial images of the same person (hereinafter simply referred to as the face information of the same person) are already stored in feature value storage unit 134 based on the similarity between the feature values, for example.

Then, if the facial image specified by position specification unit 170 in response to the user input and the face information of the same person are not yet stored in feature value storage unit 134, face correlation unit 174 stores the feature value as new face information in feature value storage unit 134.

On the other hand, if the facial image specified by position specification unit 170 in response to the user input and the face information of the same person are already stored in feature value storage unit 134, face correlation unit 174 correlates the specified facial image with the face information of the same person stored in feature value storage unit 134. Specific processing by face correlation unit 174 is described below.

Feature value storage unit 134 stores multiple pieces of face information, each of which is obtained by compiling the multiple feature values extracted from the multiple facial images of the same person, so as to correspond to the number of the persons. Face correlation unit 174 extracts the similarity between the feature value extracted by feature value extraction unit 176 and each of the multiple feature values of the multiple pieces of the face information read from feature value storage unit.

Specifically, if there is only one feature value stored regarding one piece of the face information, then face correlation unit 174 derives the similarity between the feature value extracted by feature value extraction unit 176 and the one feature value regarding the one piece of the face information stored in feature value storage unit 134. On the other hand, if there are multiple feature values put together and stored regarding the one piece of the face information, then face correlation unit 174 calculates the similarities respectively between the feature value extracted by feature value extraction unit 176 and the multiple feature values regarding the one piece of face information stored in feature value storage unit 134, and determines the highest similarity among the one or multiple similarities thus derived as the similarity between the feature value output from feature value extraction unit 176 and the multiple feature values regarding the one piece of face information. When the multiple pieces of the face information are stored in feature value storage unit 134, face correlation unit 174 performs the above-described derivation processing of the similarity, regarding the one piece of the face information, on all the multiple pieces of the face information.

As for the specific derivation processing of the similarity, face correlation unit 174 first finds similarities d0, d1, d2, . . . , and dn (n is a positive number) for each feature point by use of the feature value output from feature value extraction unit 176 and the one feature value regarding the one piece of face information, for example, which is read from feature value storage unit 134 and in accordance with a method such as a normalized correlation operation.

Subsequently, face correlation unit 174 derives similarity vectors (a set of similarities) D=(d0, d1, d2, . . . , and dn) while using, as elements, similarities d0, d1, d2, . . . , and dn of each feature point obtained by the normalized correlation operations.

Face correlation unit 174 derives a similarity Fi as the entire face from similarity vectors D by using an AdaBoost algorithm or a support vector machine (SVM), for example. Then, face correlation unit 174 derives the similarities Fi regarding all the multiple feature values of the one piece of the face information, and determines the largest value thereof as similarity F between the feature value output from feature value extraction unit 176 and the multiple feature values regarding the one piece of the face information.

Face correlation unit 174 derives the above-described similarities F of all the face information. If the largest one among derived similarities F is smaller than a predetermined first threshold, face correlation unit 174 judges that the facial image specified by position specification unit 170 and the face information of the same person are not yet stored in feature value storage unit 134.

Then, face correlation unit 174 causes feature value storage unit 134 to store the feature value output from feature value extraction unit 176 as the new feature value of the face information. Thereafter, face correlation unit 174 correlates the facial image specified by position specification unit 170 with the face information newly stored in feature value storage unit 134 as belonging to the same person.

On the other hand, if the largest one among similarities F derived regarding all the face information is equal to or above the predetermined first threshold, face correlation unit 174 judges that the piece of the face information representing largest similarity F belongs to the same person as in the facial image specified by position specification unit 170 and that the face information of the same person is already stored in feature value storage unit 134. Thereafter, face correlation unit 174 correlates the facial image specified by position specification unit 170 with the piece of the face information being stored in feature value storage unit 134 and representing largest similarity F as belonging to the same person.

Further, face correlation unit 174 may correlate the facial image specified by position specification unit 170 with the piece of the face information stored in feature value storage unit 134 based on the operation input of the user by way of operating unit 106, for example. Specifically, when the user specifies (selects) the one of the facial images from the image data held by image holding unit 124 as described previously and also selects the face information of the person of the subject for which the user is about to store the feature value from the pieces of the face information associated with the feature values that are previously stored in feature value storage unit 134, face correlation unit 174 can correlate the facial image specified by position specification unit 170 with the piece of the face information in feature value storage unit 134 selected by the user as belonging to the same person without executing the judgment processing for the same person by way of derivation of the similarities.

In this case, the facial image specified by position specification unit 170 is correlated with the piece of the face information without derivation of the similarities. Hence it is possible to start with a first facial image (a first frame) of the facial images to be specified and tracked by position specification unit 170 as a target of storing the feature value. Further, even if the image includes only one frame (in the case of a photo shoot), for example, position specification unit 170 can also define the first facial image as the target of storing the feature value by specifying but not tracking the facial image.

Then, feature value extraction unit 176 extracts the feature values respectively by use of the pieces of the image information continuously acquired regarding the facial images specified by position specification unit 170.

Storage control unit 178 compares the feature value extracted by feature value extraction unit 176 with the one or multiple feature values regarding the piece of the face information correlated with the specified facial image, and adds the extracted feature value to the piece of the face information and stores the information in feature value storage unit 134 when a predetermined condition is satisfied.

According to the configuration of storage control unit 178 as described above, only the feature value of the facial image among the specified facial images, which satisfies the predetermined condition, is automatically stored in feature value storage unit 134. Hence it is possible to specify the face appropriately in the recognition mode and thereby to improve user operability.

After the facial image specified by position specification unit 170 is correlated with the face information in feature value storage unit 134 as belonging to the same person by face correlation unit 174 as described above, a facial image which is yet to be registered regarding (or is different from) the face information of the same person is then extracted and the feature value of the extracted facial image is stored in feature value storage unit 134.

A predetermined condition for extracting the different facial image of the same person is that the similarities between the feature value newly extracted by feature value extraction unit 176 and the one or multiple feature values regarding the piece of face information correlated with the facial image specified by position specification unit 170 and stored in feature value storage unit 134 are below a predetermined value.

Here, when similarity F is below the predetermined value (a second threshold), it is conceivable that both the current facial image and the facial image registered in advance belong to the same person, but these facial images show different orientations or different expressions of the face. Accordingly, storage control unit 178 causes feature value storage unit 134 to store the feature value of the above-described facial image having the different orientation or expression of the face.

On the other hand, when similarity F is equal to or above the second threshold, it is conceivable that both the current facial image and the facial image registered in advance represent the same orientation and expression of the face. In this case, registration of the current facial image does not contribute very much of an improvement in recognition accuracy in a recognition mode to be described later for judging whether or not the face in the image is registered already. Hence storage control unit 178 does not allow feature value storage unit 134 to store the feature value of the above-described facial image.

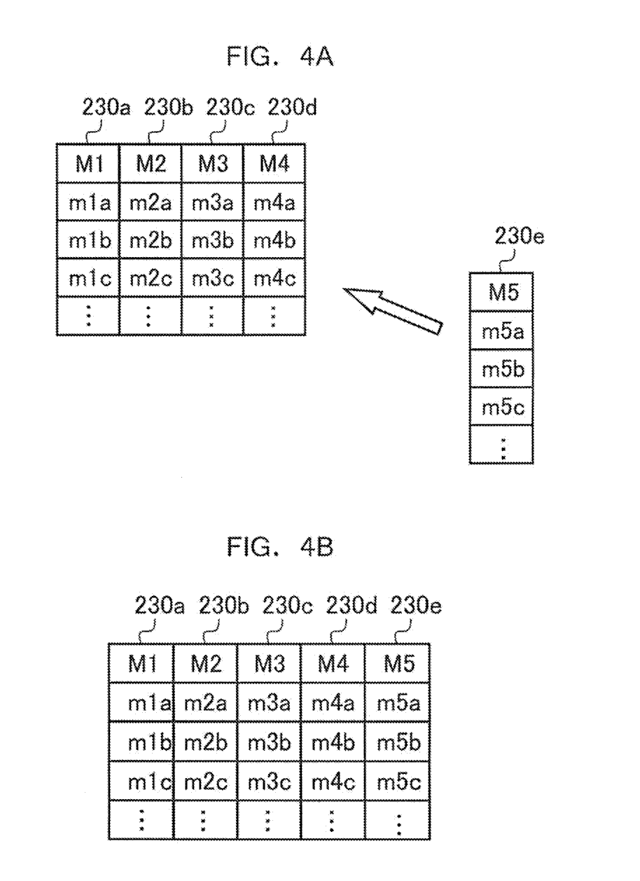

FIG. 4 is an explanatory view for explaining control to store feature values in feature value storage unit 134 according to the first embodiment. As shown in FIG. 4A, feature value storage unit 134 stores indices M1, M2, M3, and M4 and values m1a, m1b, and so forth of the respective feature points of arbitrary feature values 230a to 230d of the face information. Here, it is assumed that feature value 230e extracted from the facial image correlated with the face information as belonging to the same person is newly output from feature value extraction unit 176.

In this case, storage control unit 178 derives the similarities between respective feature values 230a to 230d of the face information and newly extracted feature value 230e, and then compares the largest feature value, which is assumed to be feature value 230d in this case, for example, with the second threshold. If the relevant feature value is equal to or above the second threshold, storage control unit 178 does not allow feature value storage unit 134 to store the feature value. On the other hand, if the feature value is below the second threshold, feature value storage unit 134 is allowed to store feature value 230e as the feature value of the face information as shown in FIG. 43.

The feature value stored in feature value storage unit 134 is used in the recognition mode for deriving the similarity to the feature value extracted from the facial image included in the image generated by image capturing unit 120. Image processing apparatus 100 of this embodiment is configured to judge whether or not a candidate for the feature value which is about to be stored is different from the feature value which is already stored based on the similarity serving as the same judgment standard as in the recognition mode. Accordingly, it is possible to reliably extract multiple different feature values regarding the same person which are also effective in the recognition mode, and to improve recognition accuracy with little comparison processing.

The above-described storage of the feature values is executed in the registration mode for registering the feature value of the specified facial image upon the operation input by the user, for example. When the user performs the operation input to start the registration mode and continues to shoot the face that the user wishes to register, feature value extraction unit 176 sequentially extracts the feature values regarding the specified facial image which is correlated with the face information by face correlation unit 174, and storage control unit 178 registers the feature values satisfying the predetermined condition among the extracted feature values as appropriate.

At this time, display control unit 180 causes viewfinder 108 to display an image showing the number of the feature values of the face information correlated with the specified facial image stored in feature value storage unit 134 while overlapping that image with a generated image of the subject. For example, an assumption is made that three pieces of feature values are stored already in a case where a maximum of eight pieces of the feature values can be stored regarding face information on a single person. In this case, a pie chart with a ⅜-painted portion is displayed. In this way, display control unit 180 causes viewfinder 108 to display the image indicating the number of the feature values actually stored in comparison with the maximum storable number of the feature values.

According to this configuration, the user is able to visually check the image indicating the number of the feature values of the displayed face information and to check progress of the storage of the feature values of the facial image. Hence it is possible to improve user operability.

If registration of the maximum number of the feature values, such as eight pieces, is completed regarding the face of the person targeted for registration or if the registration mode is terminated by the operation input by the user, then the mode transitions to an input mode for inputting personal information of the registration target for which the feature values are registered.

Display control unit 180 causes viewfinder 108 to display a message such as “please input the name of the person you registered” or “please input the date of birth of the person you registered”. Then, through operating unit 106, the user inputs the personal information on the target for registration of the feature values such as the name or the data of birth. Storage control unit 178 correlates the personal information or data information indicating the date and time at the point of registration with the feature values and causes feature value storage unit 134 to store the correlated information. Alternatively, the user may be input the personal information afterward instead of inputting immediately.

Moreover, if the feature values for the person of the subject are already stored in feature value storage unit 134 at the time of normal shooting and the number of the feature values already stored is below the maximum number or if a predetermined time period has passed since the date and time indicated by the data information, the mode may be automatically transitioned to the registration mode. In that case, display control unit 180 causes viewfinder 108 to display a message such as “do you continue registration of Mr. A?” so as to allow the user to check the face information targeted for registration of the feature values and to select appropriateness of transition to the registration mode.

Here, although feature value storage unit 134 is configured to store the feature values for each piece of the face information, it is also possible to store the original facial images themselves which are used for extracting the feature values. As the facial images are also stored as described above, the user can visually check the facial image actually used for the face recognition in the recognition mode. Accordingly, the user can delete facial images containing extreme facial expressions or facial images that are deemed to be unnecessary from feature value storage unit 134. In this case, feature value storage unit 134 may store only the facial images without storing the feature values, and feature value extraction unit 176 may extract the feature values based on the facial images when reading the facial images from feature value storage unit 134.

### (Recognition Mode)

The feature values stored in feature value storage unit 134 in the above-described registration mode are used for recognizing the face of the subject in the recognition mode. When there is an instruction for transition to the recognition mode by the operation input of the user, display control unit 180 causes viewfinder 108 to display one or multiple pieces of the face information stored in feature value storage unit 134. When the user starts image capturing after selection of the desired face information, position specification unit 179 tracks the facial images regarding all the facial images included in the image data which are acquired by image capturing unit 120 and held by image holding unit 124, and outputs image information containing the coordinates of the facial images for each frame to feature value extraction unit 176.

Feature value extraction unit 176 extracts the feature values of the facial image specified by position specification unit 170 based on the coordinates of the facial images output from position specification unit 170. Storage control unit 178 derives the similarity between the feature value regarding the face information selected by the user among the feature values stored in feature value storage unit 134 and the feature value extracted by feature value extraction unit 176.

Then, if the derived similarity is equal to or above a predetermined threshold or the above-described first threshold, for example, driving circuit 158 drives focusing lens 150 and diaphragm 152 to adjust focus and exposure in accordance with the corresponding subject. Meanwhile, display control unit 180 displays an index such as a rectangular frame so as to overlap with the corresponding facial image in the image displayed on the viewfinder 108.

As described above, in this embodiment, storage control unit 178 automatically stores the feature value of the facial image of the subject regarded as the same person as the face information in feature value storage unit 134, when the orientation or the expression of the face is different and the similarity is below the second threshold. For this reason, without bothering a user in registration of the feature values, it is possible to extract the appropriate feature value with which the face can be reliably recognized.

(Image Processing Method)

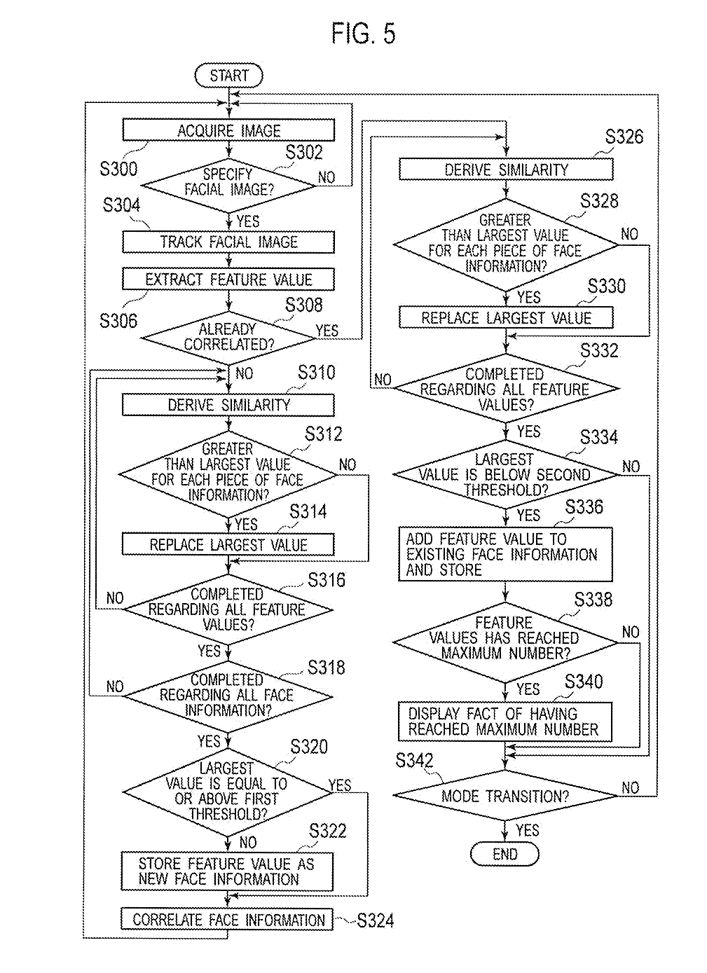

Moreover, an image processing method by use of the above-described image processing apparatus 100 is also provided. FIG. 5 is a flowchart showing a process flow of an image processing method according to the first embodiment. In particular, FIG. 5 shows a flow of the processing in the above-described registration mode.

Image capturing unit 120 acquires an image (S300), and position specification unit 170 judges whether or not one facial image is successfully specified from the image data held by image holding unit 124 (S302). If position specification unit 170 cannot specify the facial image (NO in S302), the process returns to the image acquiring step (S300).

When position specification unit 170 can specify the one facial image (YES in S302), position specification unit 170 tracks the facial image and outputs the image information on the facial image in each frame to feature value extraction unit 176 (S304). Feature value extraction unit 176 extracts the feature value regarding the facial image tracked by position specification unit 170 if the face orientation derived by face orientation derivation unit 172 has the pitch angle in the range, for example, from −15° to +15° and the yaw angle in the range, for example from −30° to +30°, and if the probability of the facial image shown in the image information and the probability of being the feature point respectively satisfy the given conditions which are predetermined so as to respectively correspond thereto (S306).

Face correlation unit 174 judges whether or not the facial image specified by position specification unit 170 is correlated with the face information stored in feature value storage unit 134 (S308). If the facial image is not correlated (NO in S308), face correlation unit 174 extracts the similarity between the feature value extracted by feature value extraction unit 176 and one of the multiple feature values regarding the one piece of the face information among the multiple pieces of the face information read from feature value storage unit 134 (S310). Thereafter, face correlation unit 174 compares the largest value of the similarity derived so far and the similarity derived at that point regarding the face information on the feature value used at that point for deriving the similarity (S312). If the similarity derived at that point is greater than the largest value of the similarity derived so far (YES in S312), face correlation unit 174 replaces the largest value of the similarity with the similarity derived at that point regarding the targeted face information (S314).

Face correlation unit 174 judges whether or not derivation of the similarities is completed regarding all the feature values of the one piece of the face information read from feature value storage unit 134 (S316). If the derivation of the similarities is not yet completed (NO in S316), face correlation unit 174 returns to the similarity derivation step (S310) and performs similar processing regarding feature values from which similarities are not yet derived.

If derivation of the similarities is completed regarding all the feature values of the one piece of the face information read from feature value storage unit 134 (YES in S316), face correlation unit 174 judges whether or not derivation of the similarities is completed regarding all the feature values of the face information read from feature value storage unit 134 (S318). If derivation of the similarities is not yet completed (NO in S318), face correlation unit 174 returns to the similarity derivation step (S310) and performs the similar processing regarding feature values of other face information from which similarities are not yet derived.

If derivation of the similarities is completed regarding all the feature values of the face information read from feature value storage unit 134 (YES in S318), face correlation unit 174 judges whether or not the largest similarity among the largest values of the derived similarities regarding the respective pieces of the face information is equal to or above the first threshold (S320). If the relevant similarity is equal to or above the first threshold (YES in S320), face correlation unit 174 judges that the face information belonging to the same person as the facial image specified by position specification unit 170 is already stored in feature value storage unit 134 and correlates the facial image specified by position specification unit 170 with the corresponding face information (S324). If the relevant similarity is below the first threshold (NO in S320), face correlation unit 174 judges that the face information belonging to the same person as the facial image specified by position specification unit 170 is not yet stored in feature value storage unit 134 and causes feature value storage unit 134 to store the extracted feature value as the feature value of new face information (S322), and correlates the facial image specified by position specification unit 170 with the new face information (S324). Thereafter, the process returns to the image acquiring step (S300).

In the correlation judging step (S308), if the facial image specified by position specification unit 170 is correlated with the face information stored in the feature value storage unit 134 (YES in S308), storage control unit 178 derives the similarity between the feature value extracted by feature value extraction unit 176 and one of other feature values of the same face information (S326). Thereafter, storage control unit 178 compares the largest value of the similarity derived so far and the similarity derived at that point regarding the other feature values of the same face information (S328). If the similarity derived at that point is greater than the largest value of the similarity derived so far (YES in S328), storage control unit 178 replaces the largest value of the similarity with the similarity derived at that point regarding the targeted face information (S330).

Storage control unit 178 judges whether or not derivation of the similarities is completed regarding other feature values of the same face information (S332). If the derivation of the similarities is not yet completed (NO in S332), storage control unit 178 returns to the similarity derivation step (S326) and performs similar processing regarding feature values from which similarities are not yet derived.

When derivation of the similarities is completed regarding all the other feature values of the same face information (YES in S332), storage control unit 178 judges whether or not the largest value of the derived similarities satisfies a predetermined condition, i.e., whether or not the relevant value is below the second threshold (S334). If the relevant value is below the second threshold (YES in S334), storage control unit 178 causes feature value storage unit 134 to store the feature value newly extracted by feature value extraction unit 176 as the feature value of the existing face information belonging to the same person (S336). Thereafter, central control unit 136 judges whether or not the number of the feature values regarding the targeted piece of face information stored in feature value storage unit 134 has already reached the maximum number (S338). If the number of the feature values has reached the maximum number (YES in S338), display control unit 180 causes viewfinder 108 to display the fact of having reached the maximum number of the feature values to be stored regarding the one piece of the face information and thereby causes termination of the registration mode (S340).

When the predetermined condition is not satisfied (NO in S334) in the predetermined condition judging step (S334), when the number of the feature values has not reached the maximum number (NO in S338) in the maximum number judging step (S338), and after the maximum number reach displaying step (S340), central control unit 136 judges whether or not there is an instruction for termination of the registration mode by way of the operation input by the user (S342). When there is no instruction for termination (NO in S342), the process returns to the image acquiring step (S300). If there is the instruction for termination (YES in S342), the registration mode is terminated.

As described above, according to the image processing method using image processing apparatus 100, without bothering a user, it is possible to extract the appropriate feature value with which the face can be reliably recognized.

### Second Embodiment

In the above-described first embodiment, storage control unit 178 is configured to derive the similarity and to compare the similarity with the Second threshold for judging whether or not it is appropriate to cause feature value storage unit 134 to store the newly extracted feature value. A second embodiment describes an image processing apparatus 400 configured to make a judgment solely in light of an angle of a face which has a large influence on the feature value. It is to be noted that constituents which are substantially the same as those in the above-described image processing apparatus 100 are designated by the same reference numerals and description thereof are omitted.

### (Image Processing Apparatus 400)

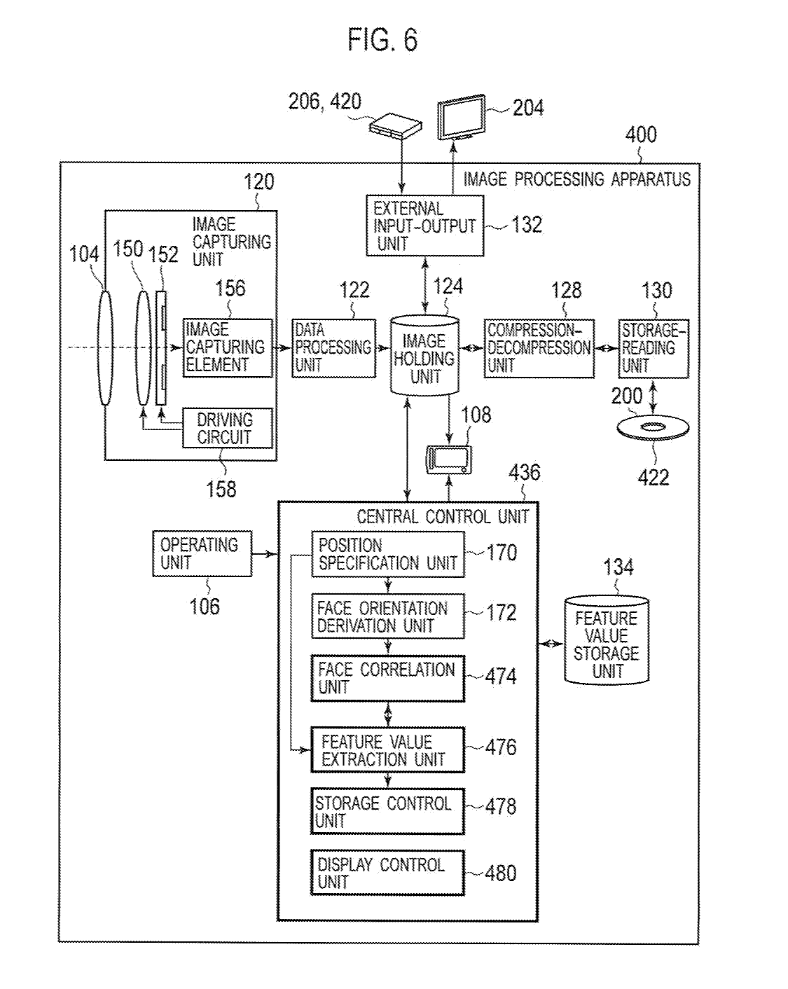

FIG. 6 is a functional block diagram showing a schematic configuration of image processing apparatus 400 according to a second embodiment. Image processing apparatus 400 includes operating unit 106, image capturing unit 120, data processing unit 122, image holding unit 124, viewfinder 108, compression-decompression unit 128, storage-reading unit 130, external input-output unit 132, feature value storage unit 134 functioning as a storage unit, and central control unit 436. Operating unit 106, image capturing unit 120, data processing unit 122, image holding unit 124, viewfinder 108, compression-decompression unit 128, storage-reading unit 130, external input-output unit 132, and feature value storage unit 134 have substantially the same functions as the constituents already stated in conjunction with the first embodiment and repetitive description thereof is omitted. Here, central control unit 436 having a different configuration is mainly explained.

Central control unit 436 includes a semiconductor integrated circuit including a central processing unit (CPU) and a signal processing device (DSP) and is configured to manage and control entire image processing apparatus 400 by use of a predetermined program. Meanwhile, central control unit 436 also functions as position specification unit 170, face orientation derivation unit 172, face correlation unit 474, feature value extraction unit 476, storage control unit 478, and display control unit 480.

Face correlation unit 474 performs similar processing to that of face correlation unit 174 of the first embodiment and correlates the specified facial image with the face information. At this time, the face information to be stored in feature value storage unit 134 contains not only the feature value but also a face orientation. Accordingly, face correlation unit 474 correlates the face information, which is formed by compiling one or multiple feature values described above and the face orientations, with the specified facial image.

Feature value extraction unit 476 compares the face orientation derived by face orientation derivation unit 172 with one or more face orientations in the face information correlated with the facial image specified by position specification unit 170, and extracts the feature value of the specified facial image when a predetermined condition is satisfied. In this embodiment, feature value extraction unit 476 is configured to extract the feature value of the specified facial image only when the predetermined condition is satisfied. However, feature value extraction unit 476 may extract all the feature values of the specified facial image irrespective of the predetermined condition.

Storage control unit 478 compares the face orientation derived by face orientation derivation unit 172 with the one or multiple face orientations in the face information correlated with the facial image specified by position specification unit 170, and causes feature value storage unit 134 to store the feature value newly extracted by feature value extraction unit 476 and the face orientation derived by face orientation derivation unit 172 in addition to the face information when the predetermined condition is satisfied.

Meanwhile, in this embodiment, the predetermined condition is defined such that the face orientation derived by face orientation derivation unit 172 is not contained in any of one or multiple ranges including the face orientation regarding the face information correlated with the facial image specified by position specification unit 170 among a predetermined number of ranges regarding the face orientations to be categorized based on the pitch angle and the yaw angle.

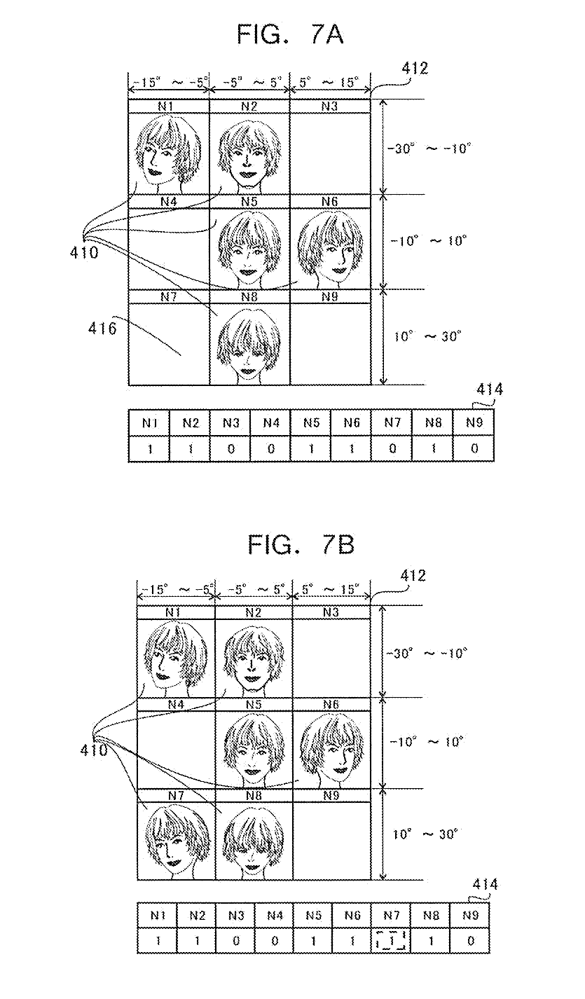

FIG. 7 is an explanatory view for explaining classification of facial images based on face orientations according to the second embodiment. FIG. 7A is an explanatory view for explaining a state of storage of the feature values regarding a certain piece of the face information while FIG. 7B is an explanatory view for explaining a state after a new feature value is added to FIG. 7A. In this embodiment, feature value storage unit 134 stores the facial images (such as facial images 410 having mutually different face orientations as shown in FIG. 7A and FIG. 7B) instead of the feature values. In FIGS. 7A and 7B, table 412 shows the facial images itself recorded in feature value storage unit 134, and table 414 shows presence and absence of records of the facial images contained in the ranges of predetermined face orientations.

In the second embodiment, face orientation derivation unit 172 derives the pitch angle and the yaw angle of the facial image as in the first embodiment, and feature value extraction unit 476 extracts the feature value if the pitch angle is in the range from −15° to +15° and the yaw angle is in the range from −30° to +30°.

Feature value extraction unit 476 judges which one of ranges shown in FIG. 7A (ranges from −15° to −5°, from −5° to 5°, and from 5° to 15° for the pitch angle, while ranges from −30° to −10°, from −10° to 10°, and from 10° to 30° for the yaw angle) each of the pitch angle and the yaw angle defining the orientation of the facial image newly derived by face orientation derivation unit 172 is included. Here, feature value extraction unit 476 does not extract the feature value of the facial image if a flag on table 414 shown in FIG. 7A corresponding to that range among multiple flags stored and correlated with the feature values regarding the face information of the same person has a value “1”, indicating that the relevant feature value has been stored already.

On the other hand, feature value extraction unit 476 extracts the feature value of the facial image specified by position specification unit 170 if the relevant flag shown in FIG. 7A has a value “0” indicating that the relevant feature value is yet to be stored, i.e., if the face orientation of the facial image newly derived by face orientation derivation unit 172 is not included in any of the one or multiple ranges including the face orientation regarding the face information correlated with the facial image specified by position specification unit 170, and stored in feature value storage unit 134, among the predetermined number (nine in this embodiment) of ranges regarding the face orientations to be categorized based on the pitch angle and the yaw angle. Then, storage control unit 478 stores the feature value extracted by feature value extraction unit 476 and the face orientation derived by face orientation derivation unit 172 in addition to the face information, and changes the corresponding flag on table 414 to “1”.

For example, if the face orientation in the facial image newly derived by face orientation derivation unit 172 has the pitch angle and the yaw angle corresponding to a position 416 for N7 shown in FIG. 7A (the pitch angle in the range from −15° to 15° and the yaw angle in the range from −10° to)-30°, then the feature value is newly stored as shown in FIG. 7B and the flag is changed from “0” to “1”.

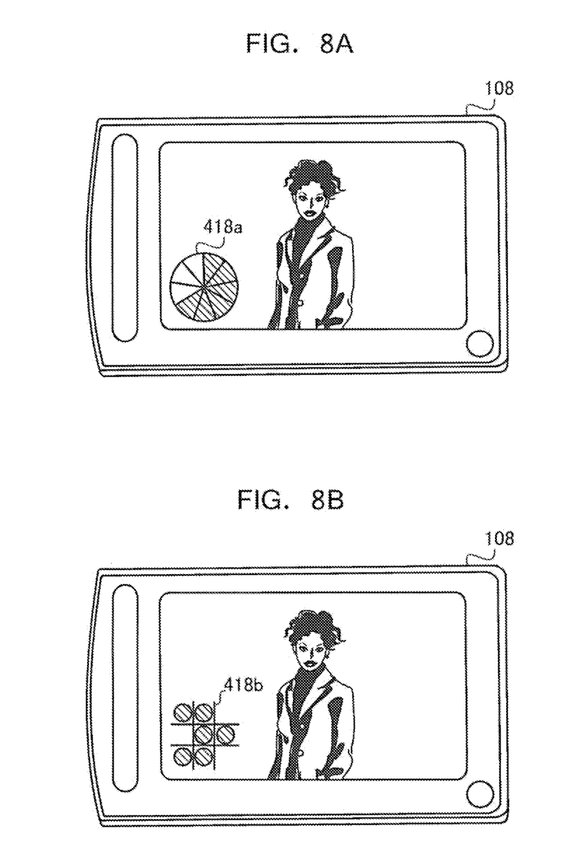

FIGS. 8A and 8B are explanatory views for explaining image 418a showing the number of feature values and image 418b showing ranges including a face orientation. As shown in FIGS. 8A and 8B, display control unit 480 causes viewfinder 108 to display an image indicating any one or both of the number of actually stored feature values in comparison with an upper limit number of storable feature values and ranges including the face orientations which are actually stored in comparison with the predetermined number of ranges regarding the face orientations which are categorized based on the pitch angle and the yaw angle.

For example, when table 412 shown in FIG. 7B is recorded in feature value storage unit 134, display control unit 480 can cause viewfinder 108 to display a pie chart (such as image 418a shown in FIG. 8A) similarly to display control unit 180 of the first embodiment, with a 6/9 portion being painted (or hatched) so as to represent the number (six in this case) of the actually stored feature values in comparison with the upper limit number (nine in this case) of the storable feature values.

Meanwhile, in this embodiment, display control unit 480 causes viewfinder 108 to display an image having 3×3 cells in which cells corresponding to positions N1, N2, N5, N6, N7 and N8 are painted (such as image 418b shown in FIG. 8B as the ranges including the face orientations which are actually stored in comparison with the predetermined number of ranges regarding the face orientations. In this case, six cells are painted out of the nine cells arranged in the 3×3 matrix. Accordingly, the image indicates that the upper limit number of the storable feature values is 9 while the number of the actually stored feature values is 6. The user can set up which image out of image 418a and image 418b is to be displayed by way of the operation input.

This embodiment is configured to display not only the image indicating the number of the feature values but also the image clarifying the ranges of the face orientations for which the feature values are actually stored as well as the ranges for which the feature values are not stored. Accordingly, there is an advantage that the user can easily understand a situation as to which face orientation is supposed to be captured or which face orientation is less necessary, for example.

The face orientation has a large influence on extraction of the feature value of the facial image. Since image processing apparatus 400 of this embodiment is configured to store the feature value solely in light of the different face orientations, it is possible to store the feature values representing only the differences in the face orientations while excluding influences of the expressions of the face.

Moreover, the face orientation having the large influence on the feature value can be categorized based on the pitch angle and the yaw angle. In this embodiment, the face orientations necessary for facilitating the recognition are predetermined by the frame defining the certain ranges of the pitch angle and the yaw angle. Meanwhile, storage control unit 478 does not store the feature values which are classified into the same face orientation but stores the feature values which are classified into different face orientations. For this reason, storage control unit 478 can make reference to the feature values representing various face orientations regarding the face orientations having the large influence in the recognition mode.

Furthermore, image processing apparatus 400 can import feature values of facial images which are generated by devices other than image processing apparatus 400. For example, when external input-output unit 132 accepts a feature value output from another image processing apparatus or from external device 420 that can extract a feature value from a facial image, storage control unit 478 causes feature value storage unit 134 to store the accepted feature value. Similarly, when storage-reading unit 130 reads a feature value of storage medium 422 that stores the feature value, storage control unit 478 causes feature value storage unit 134 to store the feature value thus read out.

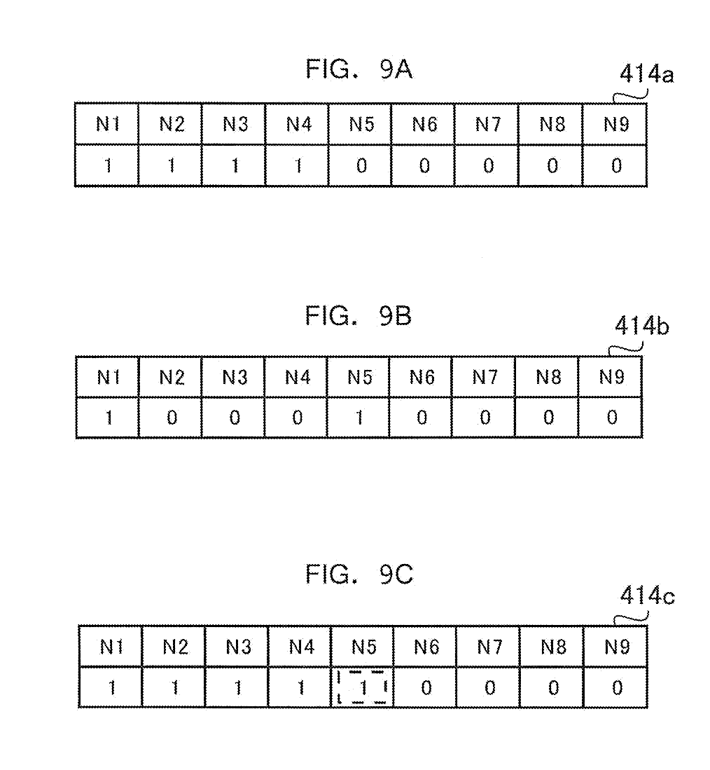

FIGS. 9A, 9B and 9C are explanatory views for explaining processing when feature values are acquired from external apparatus 420. In particular, FIG. 9A is table 414a showing ranges of the face orientations to which the feature values of an arbitrary piece of the face information stored in feature value storage unit 134 are classified. FIG. 9B is table 414b showing ranges of the face orientations to which the feature values of the facial image belonging to the same person as the person of an arbitrary piece of the face information acquired from external device 420 are classified. FIG. 9C is table 414c showing ranges of the face orientations to which the feature values of the arbitrary piece of the face information stored in feature value storage unit 134 are classified after reflecting the feature values acquired from external device 420. Respective flags N1 to N9 appearing in FIGS. 9A to 9C are assumed to correspond to presence or absence of the feature values in certain ranges of the face orientations as similar to the respective flags N1 to N9 appearing in FIGS. 7A and 7B.

Storage control unit 478 compares the feature value of the targeted piece of the face information with the face orientation of the facial image originally used for extracting the feature value if the similarity between the feature value accepted from external device 420 (or read from storage medium 422) and the feature value of the face information stored in feature value storage unit 134 is equal to or above the first threshold or if the face information is selected by the operation input by the user.

In this comparison, storage control unit 478 does not update the feature value in the range of the face orientation in which the flag shown in FIG. 9A is set to “1”. Instead, if the feature values accepted from external device 420 includes the feature value of the face orientation corresponding to any part of the range (N5 to N9 in FIG. 9A) of the face orientations in which the flag is set to “0”, then storage control unit 478 causes feature value storage unit 134 to store the feature value. In FIG. 9B, there is the feature value of the face orientation corresponding to N5. Accordingly, storage control unit 478 causes feature storage unit 134 to store this feature value. As a result, the flag in N5 is changed from “0” as shown in FIG. 9A to “1” as shown in FIG. 9C. Meanwhile, if a time point of extraction of the feature value is also stored in feature value storage unit 134 as auxiliary information and if the feature value in the range of the same face orientation is stored therein, then storage control unit 478 may be configured to preferentially store the feature value that has been extracted more recently.

When the feature value accepted from external device 420 is stored in feature value storage unit 134, storage control unit 478 can store the feature value uniformly and efficiently without storing too many feature values by using the configuration to judge whether or not to store the feature value based on the face orientation.

As described above, according to image processing apparatus 400 of this embodiment, it is possible to store the feature values representing various face orientations regarding the face orientations having the large influence in the recognition mode. Hence it is possible to improve recognition accuracy in the recognition mode.

(Image Processing Method)

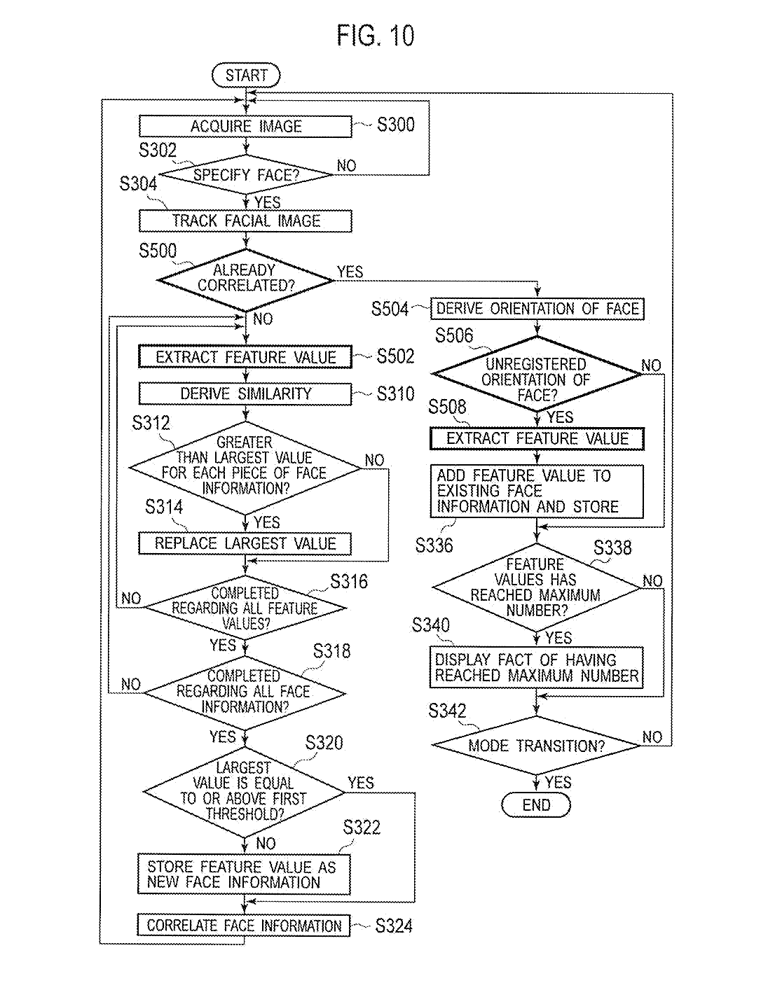

Moreover, an image processing method by use of above-described image processing apparatus 400 is also provided. FIG. 10 is a flowchart showing a process flow of an image processing method according to the second embodiment. As similar to FIG. 5, FIG. 10 shows a flow of the processing in the registration mode in particular. The procedures substantially equal to those in the above-described image processing method of the first embodiment are designated by the same reference numerals and explanation thereof is omitted.

This embodiment is different from the first embodiment in that face correlation unit 174 judges whether or not the facial image specified by position specification unit 170 is correlated with the face information stored in feature value storage unit 134 (S500) after the facial image tracking step (S304) and before the feature value extracting step (S306 in FIG. 5).

If the facial image is not correlated (NO in S500), feature value extraction unit 476 extracts the feature value of the facial image specified by position specification unit 170 (S502). Hereinbelow, the procedures from the similarity extracting step (S310) to the face information correlating step (S324) are substantially equal to those in the image processing method described in the first embodiment. Hence the procedures are designated by the same reference numerals and explanation thereof is omitted.

In the correlation judging step (S500), if the facial image specified by position specification unit 170 is correlated with the face information stored in feature value storage unit 134 (YES in S500), then face orientation derivation unit 172 derives the face orientation of the facial image specified by position specification unit 170 (S504).

Feature value extraction unit 476 compares the face orientation derived by face orientation derivation unit 172 with one or multiple face orientations regarding the face information correlated with the facial image specified by position specification unit 170, and judges whether or not a predetermined condition is satisfied, i.e., whether or not the face orientation derived by face orientation derivation unit 172 is different from any of the predetermined number of the face orientations categorized based on the pitch angle and the yaw angle of the face information correlated with the specified facial image (whether or not the face orientation is unregistered) (S506). If the face orientation is different (YES in S506), feature value extraction unit 476 extracts the feature value of the facial image specified by position specification unit 170 (S508) and storage control unit 478 causes feature value storage unit 134 to store the feature value extracted by feature value extraction unit 476 and the face orientation derived by face orientation derivation unit 172 in addition to the existing face information belonging to the same person (S336). The process goes to the maximum number judging step (S338) if the face orientation derived by face orientation derivation unit 172 is the same as any one of the predetermined number of the face orientations categorized based on the pitch angle and the yaw angle of the face information correlated with the specified facial image (NO in S506).

Hereinbelow, the procedures from the maximum number judging step (S338) to the mode transition step (S324) are substantially equal to those in the image processing method described in the first embodiment. Hence the procedures are designated by the same reference numerals and explanation thereof is omitted.

As described above, according to the image processing method using image processing apparatus 400, it is possible to store the feature values of the various face orientations, and thereby to improve recognition accuracy in the recognition mode.

Although the preferred embodiments are described above with reference to the accompanying drawings, it is needless to say that the invention is not limited only to those embodiments. It is obvious to those skilled in the art that various alternative examples or modified examples can be anticipated within the scope as defined in the appended claims. It is to be understood that those examples are also encompassed by the technical scope of the invention.

Moreover, the respective steps in the image processing method of this specification do not always have to be carried out in a temporal sequence according to the order of description as the flowchart. The method may also include parallel processing or subroutine processing.

### INDUSTRIAL APPLICABILITY

The invention is applicable to an image processing apparatus and an image processing method configured to store a feature value of a facial image in order to specify a subject.

1. An image processing apparatus comprising:
an image acquisition unit that acquires an image;
a position specification unit that specifies one facial image from the image;
a face correlation unit that correlates the specified facial image with face information obtained by compiling one or more stored feature values stored in a storage unit, thereby identifying one or more correlated feature values;
a feature value extraction unit that extracts an extracted feature value of the specified facial image; and
a storage control unit that compares the extracted feature value with the one or more correlated feature values of the face information correlated with the specified facial image, and causes the storage unit to additionally store the extracted feature value, as a storable feature value, as the face information when similarities between the extracted feature value and the one or more correlated feature values of the face information correlated with the specified facial image are below a predetermined value.

2. (canceled)

3. The image processing apparatus according to claim 1,
further comprising:
a display control unit that causes a display unit to display an image indicating the number of the actually stored feature values in comparison with an upper limit number of storable feature values.

4. An image processing apparatus comprising:
an image acquisition unit that acquires an image;
a position specification unit that specifies one facial image from the image;
a face correlation unit that correlates the specified facial image with face information obtained by compiling one or more stored feature values and stored face orientations stored in a storage unit, thereby identifying one or more correlated feature values and one or more correlated face orientations;
a face orientation derivation unit that derives a derived face orientation of the specified facial image;
a feature value extraction unit that extracts an extracted feature value of the specified facial image; and
a storage control unit that compares the derived face orientation with the one or more correlated face orientations of the face information correlated with the specified facial image, and causes the storage unit to additionally store the extracted feature value and the derived face orientation as the face information the derived face orientation is not contained in any of one or more ranges including the correlated face orientations regarding the face information correlated with the specified facial image among a predetermined number of ranges regarding the face orientations categorized based on a pitch angle and a yaw angle.

5. (canceled)

6. The image processing apparatus according to claim 4,
further comprising:
a display control unit that causes a display unit to display an image indicating any one or both of the number of the actually stored feature values in comparison with an upper limit number of the storable feature values, and ranges including the actually stored face orientations in comparison with a predetermined number of ranges regarding the face orientations categorized based on the pitch angle and the yaw angle.

7. An image processing method comprising the steps of:
acquiring an image and specifying one facial image from the image;
correlating the specified facial image with face information obtained by compiling one or more stored feature values;
extracting an extracted feature value of the specified facial image; and
comparing the extracted feature value with the one or more stored feature values of the face information correlated with the specified facial image and additionally storing the extracted feature value as the face information when similarities between the extracted feature value and correlated feature values of the face information correlated with the specified facial image are below a predetermined value.

8. An image processing method comprising the steps of:
acquiring an image and specifying one facial image from the image;
correlating the specified facial image with face information obtained by compiling one or more stored feature values and one or more stored face orientations;
deriving a derived face orientation of the specified facial image; and
comparing the derived face orientation with the one or more stored face orientations of the face information correlated with the specified facial image, and additionally storing the extracted feature value of the facial image and the face orientation as the face information when the derived face orientation is not contained in any of one or more ranges including the correlated face orientations regarding the face information correlated with the specified facial image among a predetermined number of ranges regarding the face orientations categorized based on a pitch angle and a yaw angle.

9. The image processing method according to claim 8, further comprising:
displaying an image indicating the number of the actually stored feature values in comparison with an upper limit number of the storable feature values.

10. The image processing method according to claim 8, further comprising:
displaying an image indicating any one or both of the number of the actually stored feature values in comparison with an upper limit number of the storable feature values, and ranges including the actually stored face orientations in comparison with a predetermined number of ranges regarding the face orientations categorized based on the pitch angle and the yaw angle.
